(19) United States
(12) Patent Application Publication
(10) Pub. No.: US 2013/0309363 A1
(43) Pub. Date: Nov. 21, 2013

(54) Oral Colloidal Electrolyte Solution and Related Methods

(71) Applicants: Robert Davidson, Woodland Hills, CA (US); Eric Allen, Camarillo, CA (US); Edward Maliski, Thousand Oaks, CA (US); Jose Bernado, Thousand Oaks, CA (US)

(72) Inventors: Robert Davidson, Woodland Hills, CA (US); Eric Allen, Camarillo, CA (US); Edward Maliski, Thousand Oaks, CA (US); Jose Bernado, Thousand Oaks, CA (US)

(21) Appl. No.: 13/850,289

(22) Filed: Mar. 25, 2013

Related U.S. Application Data
(60) Provisional application No. 61/647,856, filed on May 16, 2012.

(51) Int. Cl. A23L 1/29

(52) U.S. Cl. CPC A23L 1/296
USPC 426/74; 426/573; 426/575; 426/576; 426/577

(57) ABSTRACT

The present invention relates to oral dosage formulations consisting of at least one active ingredient contained in a plurality of hydrophobic carriers dispersed in an aqueous medium comprising a hydrocolloid. The active ingredients include various forms of electrolytes. The formulations may further include emulsifiers, permeation enhancers, and vasodilators. The invention further relates to methods of making the oral dosage formulations.

### CROSS-REFERENCE TO RELATED APPLICATION

This application claims the benefit of U.S. provisional application No. 61/647,856, filed May 16, 2012, titled “Oral Liposomal Electrolyte Solution and Related Methods,” which is incorporated by reference herein in its entirety.

### FIELD OF THE INVENTION

The present invention relates to the field of dietary supplements, and, more particularly, to an oral colloidal electrolyte solution and related methods.

### BACKGROUND OF THE INVENTION

Electrolytes are charged compounds found in body fluids that are necessary for proper cellular and nervous function and are important in reducing cramping and fatigue, and improving performance and recovery. Electrolyte compounds ionize to both anions and cations, both of which are necessary for bodily purposes. Electrolytes include sodium, calcium, magnesium, potassium, phosphate and others, including their respective salt forms.

Electrolytes are integral to the sending of electrical signals in nervous tissue, aid in muscle function, and help with the neutralization of lactic acid in the blood. As such, electrolytes aid in the maintenance of cell homeostasis and are required for the proper function of human cells and organs.

It is known that as an individual participates in exercise, body fluid levels are depleted as sweating increases. Initially, this causes a relative increase in electrolyte levels, but such levels then rapidly deplete, which lowers athletic performance. In severe cases, the loss of electrolytes is dangerous to the health of individuals. When serum levels fall below “normal” levels, impaired performance, nausea, vomiting, dizziness, seizures, coma or death may occur.

Some individuals are prone to severe electrolyte loss. These “salty sweaters” may not be able to easily replenish lost electrolytes. Also, endurance athletes and those participating in long-term athletic activities may also have difficulty maintaining appropriate bodily electrolyte balance. Replenishment of electrolytes is especially critical for these particular individuals.

Until an electrolyte passes from the digestive tract, and into the bloodstream, the electrolyte is of little value to the body. Therefore, it is desirable to for electrolytes to be absorbed by the body as rapidly and efficiently as possible.

### SUMMARY OF THE INVENTION

In view of the foregoing background, it is therefore an object of the present invention to provide an electrolyte formulation that is quickly and efficiently absorbed by the body. This and other objects, features, and advantages in accordance with the present invention are provided by a hydrocolloidal electrolyte formulation.

In at least one aspect, the present invention is directed to an oral dosage formulation containing at least one active ingredient contained in a plurality of hydrophobic carriers dispersed in an aqueous medium comprising a hydrocolloid and an emulsifier. The active ingredients include electrolytes.

Another aspect is directed to a method for producing a hydrocolloidal electrolyte formulation.

Another aspect is directed to a method for administering a hydrocolloidal electrolyte formulation to an individual in need thereof.

These and other objects, aspects, and advantages of the present invention will be better appreciated in view of the drawings and the following detailed description of the embodiments.

### BRIEF DESCRIPTION OF THE DRAWINGS

FIG. 1 is a diagram illustrating a phospholipid molecule;

FIG. 2 is a diagram illustrating active ingredients within a micelle; and

FIG. 3 is a diagram illustrating active ingredients within a liposome.

### DESCRIPTION OF EMBODIMENTS OF THE INVENTION

In the Summary of the Invention above and in the Detailed Description of the Invention and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The term “comprises” is used herein to mean that other ingredients, steps, etc. are optionally present. When reference is made herein to a method comprising two or more defined steps, the steps can be carried in any order or simultaneously (except where the context excludes that possibility), and the method can include one or more steps which are carried out before any of the defined steps, between two of the defined steps, or after all of the defined steps (except where the context excludes that possibility).

In this section, the present invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

The inventors have developed formulations that can be used to orally deliver active ingredients via hydrophobic carriers dispersed in an aqueous medium consisting of a hydrocolloid. A hydrocolloid is a chemical substance in which colloidal particles are spread throughout water.

As used herein, the term “active ingredient” means an ingredient in the composition that produces a physiological effect in the user. Preferred active ingredients include, but are not limited to, electrolytes or any other pharmaceutically active substances or nutraceutical active substances, including drugs. A preferred concentration range of active ingredients is about 1% w/w to about 20% w/w of the formulation. However, the concentration range may be expanded or contracted, depending on the particular active ingredient or combination of active ingredients.

A formulation in accordance with an embodiment of the invention comprises one or more active ingredients, preferably electrolytes, wherein the active ingredients are contained in a plurality of hydrophobic carriers, such as oil droplets in a colloidal suspension, that may additionally provide encapsulation of the active ingredients in micelles or liposomes.

Because the formulations can be administered to a subject in need thereof, one having ordinary skill in the art will recognize that the formulations can further contain substances used for the preparation of a final dosage form as is readily understood in the pharmaceutical and nutraceutical arts. Examples of these substances include one or more excipients, diluents, disintegrants, emulsifiers, solvents, processing aids, buffering agents, colorants, flavorings, solvents, coating agents, binders, carriers, glidants, lubricants, granulating agents, gelling agents, polishing agents, suspending agent, sweetening agent, anti-adherents, preservatives, emulsifiers, antioxidants, plasticizers, surfactants, viscosity agents, enteric agents, wetting agents, thickening agents, stabilizing agents, solubilizing agents, bioadhesives, film forming agents, essential oils, emollients, dissolution enhancers, dispersing agents, or combinations thereof.

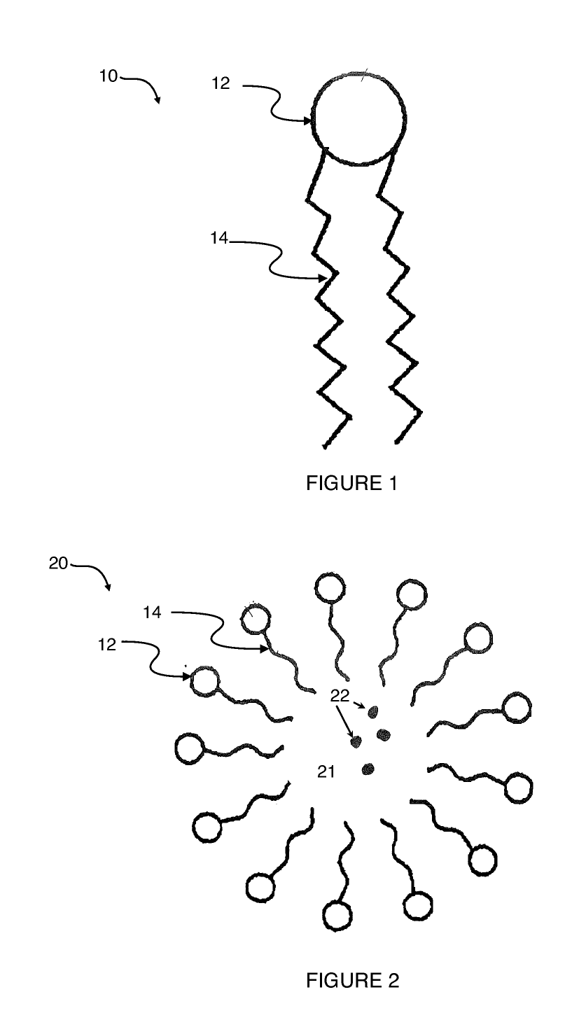

FIG. 1 illustrates a phospholipid 10, which is a type of amphiphilic lipid capable of forming lipid bilayers. Typically, phospholipids 10 comprise a phosphate head 12 and a hydrophobic tail 14. The phosphate head 12 is largely hydrophilic.

FIG. 2 illustrates a micelle 20 formed from amphiphilic molecules, such as phospholipids 10. When dispersed in an aqueous solution, the hydrophilic head regions 12 form a pocket 21 around the hydrophobic tail region 14. One or more active ingredients 22 may be encapsulated in the micelle 10.

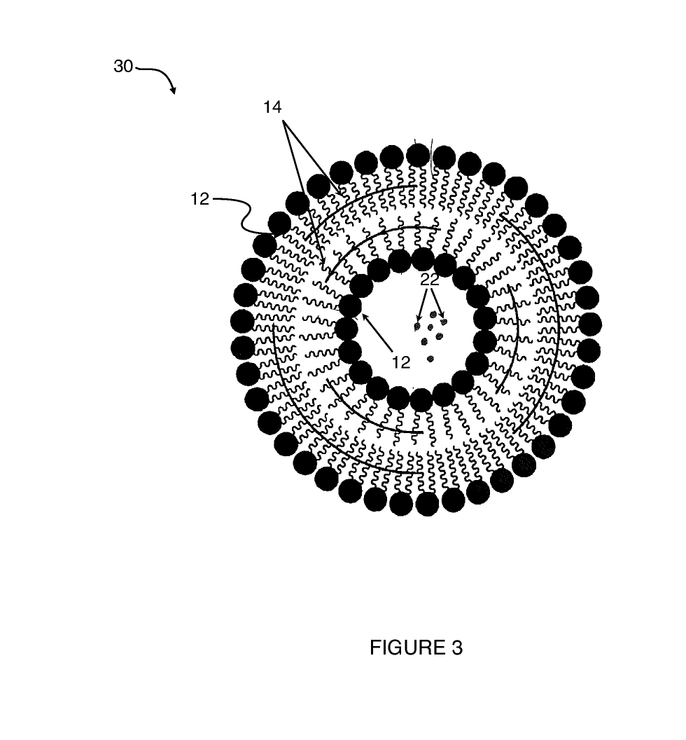

FIG. 3 illustrates a liposome 30, which is an artificially-prepared vesicle similar to a micelle 20, but composed instead of a lipid bilayer. Many substances that form micelles 20 and liposomes 30 are known. Examples of these substances include, but are not limited to, both natural and synthetic phosphatidyl-based substances including lecithins (phosphatidylcholines), hydroxylated lecithin, PEG phospholipid, hydrogenated soy phosphatidylcholine, phosphatidic acid, phosphatidylglycerol, phosphatidylethanolamine, phosphatidyl serine, sulfolipids such as sulfoquinovosyl distearoylglycerol, sulfates such as sodium lauryl sulfate, sulfonates such as dioctyl sodium sulfosuccinate, and carboxylates such as sodium deoxycholate, sodium stearate, and sodium oleate.

In at least one embodiment, phosphatidyl serine is first dispersed throughout an aqueous solution to begin to form carrier micelles 20 and liposomes 30 within the solution. The micelles 20 or liposomes 30 used in the composition of the invention may be electrically charged. This is accomplished by choosing micelle- or liposome-forming substances that can comprise ionic constituents. Phospholipids 10, for example, can be treated chemically in order to provide anionic phosphate-based functional groups in the hydrophilic head 12 region. Phosphatidyl serine in particular can be made into a mono- or di-anion by treating it with one or two equivalents of a base. Positively charged counter ions are solvated and distributed in the aqueous solution external to the liposome 30.

In some embodiments, sodium hydroxide (NaOH) is introduced to the phosphatidyl serine, and the hydroxide deprotonates the carboxyl group of the phosphatidyl serine, giving the hydrophilic part of the carrier liposomes/micelle a negative charge. The phosphatidyl serine and NaOH are mixed at high speed in water to fully disperse carrier liposomes 30 and/or micelles throughout the water so that the hydroxide evenly interacts with all of the carrier liposomes 30 and micelles. The amount of sodium hydroxide is a 1:1 molar ratio with phosphotidyl serine. It is important that each phosphatidyl serine molecule be exposed to one hydroxide molecule in order for all, or the majority, of the carrier micelles and/or liposomes 30 to become negatively charged, so that overall, the surface of the carrier liposomes 30 and micelles will have a net negative charge. It is also important to first create the negative charge on the liposomes' 30 and micelles' surfaces before introducing the active ingredients 22 because the active 22 may interfere with the hydroxides' deprotonation of the carboxyl group of the phosphatidyl serine.

The active ingredients 22 are, among other substances, electrolytes. The electrolytes of the composition can be selected, for example, from the group comprising of sodium, potassium, phosphate, bicarbonate, sulfate, chloride, calcium, magnesium, and combinations thereof. For example, the composition may contain from about 1% to about 5% (w/w) potassium; from about 5% to about 16% (w/w) sodium; from about 0.1% to about 2% (w/w) magnesium; and from about 0.1% to about 2% (w/w) calcium. As would be understood by those skilled in the art, the electrolytes are compounds that ionize when dissolved in a suitable ionizing solvent, such as water. As such, it is contemplated that salt, acid and base forms of the aforementioned electrolyte compounds may be utilized in the current invention. As such, and by way of example, the composition may contain potassium chloride, sodium chloride, magnesium glycinate, calcium chloride, acesulfame potassium, potassium sorbate, and combinations thereof. Preferably, the composition may contain about 2.75% (w/w) potassium chloride, about 13.75% (w/w) sodium chloride, about 0.5% (w/w) magnesium glycinate, and about 0.3% (w/w) calcium chloride. Also, the composition may contain phosphate in concentrations varying from about 0.1% (w/w) to about 2% (w/w). In total, the combination of active ingredients may make up from about 1% (w/w) to about 20% (w/w) of the formulation.

These electrolytes are the actives to be dispersed in hydrophobic carriers forming either micelles, liposomes, or oil droplets in a colloidal suspension comprising a hydrocolloid for delivery through the buccal mucosa and gastrointestinal tract into the blood stream. Furthermore, the actives 22 may be encapsulated in carrier liposomes 30, and delivered through the buccal mucosa and gastrointestinal tract into the bloodstream.

The hydrocolloid is a hydrogel that forms the aqueous medium around the hydrophobic carriers and is capable of holding the carriers in place for a longer duration. Non-limiting examples of hydrocolloids include cellulose derivatives such as hydroxyethylcellulose, methylcellulose, and hydroxypropyl-methylcellulose; agarose; hyaluronan; pectin; pullulan; xanthan gum; and other polymers, either synthetically or naturally derived. A particularly preferred gelling agent is pectin. A preferred concentration range of gelling agent is about 3.7% (w/w) to about 6.0% (w/w) of the formulation.

The hydrophobic carriers may include oils, such as, but not limited to, grapeseed oil. The hydrophobic carriers may also include lecithin, hydroxylated lecithin, phosphatidylserine and combinations thereof. The hydrophobic carriers generally comprise from about 0.05% (w/w) to about 3% (w/w) of the formulation.

Optionally, the formulations may include one or more emulsifiers to prevent the carriers from agglomerating and settling into a continuous oil phase. The use of an emulsifier is more important in the colloidal suspensions. Suitable emulsifiers include, but are not limited to, lecithin, glycerin, sodium stearoyl lactylate, cetearyl alcohol, polysorbates, polyoxyethylene ethers, polyethylene glycol, anisolic compounds, any conventional emulsifier, and combinations thereof. Glycerin is a particularly preferred emulsifier due to its relatively low viscosity. A preferred concentration range of emulsifier is about 1% (w/w) to about 3% (w/w) of the composition.

Optionally, the formulations may include one or more preservatives for preventing the formulation from spoiling. Suitable preservatives include, but are not limited to, antimicrobial preservatives and antioxidants. Examples include sorbic acid and its salts, benzoic acid and its salts, calcium propionate, sodium nitrite, sodium nitrate, sulfites, sulfur dioxide, sodium bisulfite, potassium hydrogen sulfite, disodium EDTA, butylated hydroxyanisole, butylated hydroxytoluene, tert-butylhydroquinone, propyl gallate, ethanol, and methylchloroisothiazolinone. Sodium benzoate and potassium sorbate are particularly preferred preservatives. A preferred concentration range of preservative is about 0.01% (w/w) to about 0.05% (w/w) of the composition.

The formulations may also include one or more permeation enhancers to assist the active ingredient(s) in permeating the buccal cell layers. Examples of permeation enhancers include, but are not limited to, menthyl acetate, DDAIP, fatty acid esters, fatty alcohol ethers, ethanol, dimethylsulfoxide, polyethylene glycol monolaurate, sesquiterpenes, terpenoids, sesquiterpenoids, and terpenes such as menthol, peppermint oil, nerolidol, nerol, linalool, citronellol, and geraniol; and combinations thereof. A particularly preferred permeation enhancer is menthol, as menthol also provides a pleasing taste for oral consumption. A preferred concentration range of permeation enhancer is about 0.2% (w/w) to about 7% (w/w) of the formulation.

Optionally, the formulations may include one or more vasodilators/vasostimulants to aid in ingredient delivery. Suitable vasodilators/vasostimulants include any conventional vasodilator such as nicotinic acid, caffeine, and combinations thereof. A preferred concentration range of vasodilator/vasostimulant is about 0.2% (w/w) to about 7% (w/w) of the formulation.

It is important to blend the active ingredients 22 with the hydrophobic carriers of the hydrocolloid solution and/or the encapsulating phospholipids 10, micelles 20, and liposomes 30 before adding ingredients for palatability. If the actives 22 are to be encapsulated via micelles or liposomes, they must always be blended into the solution before the other ingredients to ensure they are the only molecules to be encapsulated within the micelle or liposome 30. Only about 90% of the total solution amount of sodium chloride should be encapsulated with the remaining roughly 10% being placed outside the micelle or liposome 30, within the matrix solution, to aid in the buccal transport of the actives 22. A high speed blending operation will open the carrier micelles 20 and liposomes 30 to allow them 20, 30 to reform around, or encapsulate, the active molecules 22. The solution is also allowed to slightly cool at this point to allow the matrix to settle and the liposomes to fully encapsulate the actives 22.

After the micelles 20 and liposomes 30 are formed around the actives 22, the solution will no longer be blended at high speed. A high speed blend will cause the carrier micelles 20 and liposomes 30 to re-open, which will allow the active ingredients 22 to be released from encapsulation.

After the active ingredients 22 are added to the solution, blended, and allowed to rest, glycerin is added to the solution. The glycerin helps emulsify the immiscible liquids to evenly distribute solution components throughout the solution.

The remaining ingredients of the formulation are then added in succession. These ingredients will not be encapsulated in the carrier liposome or micelle. The remaining approximately 10% of the sodium chloride largely remains outside of the carrier micelles 20 and liposomes 30, and reside instead within the matrix to help shuttle the carrier micelles 20 and liposomes 30 through the buccal mucosa by active transport.

It is not desirable to open the carrier micelles 20 and liposomes 30 after the active ingredients 22 are encapsulated. The unencapsulated ingredients in the formulation are the first components exposed to the taste receptors and the buccal mucosa in the mouth. Allowing the remainder of the sodium, flavors, and sweeteners to enter into the liposomes/micelles would negate the purpose of such unencapsulated ingredients. For example, ingredients such as sweeteners and flavors that are incorporated specifically for palatability must be presented to the buccal mucosa, and should not be shielded from the mucosa by a layer of phospholipids 10.

Sugar substitutes, artificial and natural, are contemplated as sweeteners for the formulation. In particular, without limitation, stevia, aspartame, sucralose, neotame, acesulfame potassium, and saccharin may be used as sweetening agents. Natural sugar substitutes such as sorbitol and xylitol are also, without limitation, contemplated. In a preferred embodiment, sucralose, acesulfame potassium, and xylitol are used in combination to provide sweetness and palatability to the formulation.

The flavors contemplated for the formulation are, without limitation, almond, amaretto, amaretto nutty, anise, apple, apricot, banana creme, bavarian creme, bergamot, black walnut, blackberry, blueberry, brandy, bubble gum, butter, butter rum, butterscotch, cappuccino, caramel, champagne, cheesecake, cherry, cherry washington, chocolate, chocolate hazelnut, cinnamon, cinnamon roll, citrus blossom, clove, coconut, coffee, coffee keoke, coffee kona, cola, cotton candy, cranberry, cranraspberry, creme de menthe, eggnog, english toffee, ginger, grape, grapefruit pink, guava, hazelnut creamy, honey, honeydew, horchata, horehound, hot chili, irish cream, key lime, lavender, lemon, lemonade, licorice, lime, mango, maple, canadian maple, marshmallow, melon, menthol eucalyptus, mint chocolate chip, mixed berry, mountain berry, nutmeg, orange brandy, orange cream, orange, peach, peanut butter, pear, pecan, peppermint, pina colada, pineapple, pistachio, plum, pomegranate, praline, pralines and cream, pumpkin, raspberry, red licorice, root beer, royal raspberry, salt water taffy, sassafras, spearmint, strawberry banana, strawberry, strawberry kiwi, tangerine, teaberry, tropical punch, tutti-frutti, vanilla butternut, vanilla, watermelon, wintergreen. In a preferred embodiment, the flavors in the formulation are cream and strawberry.

Sodium benzoate and potassium sorbate are preservatives that are added to the formulation for the purpose of keeping the solution fresh and to prevent bacteria from growing. Preservatives contemplated for the formulation include, without limitation, antimicrobial preservatives and antioxidants. Examples include sorbic acid and its salts, benzoic acid and its salts, calcium propionate, sodium nitrite, sodium nitrate, sulfites, sulfur dioxide, sodium bisulfite, potassium hydrogen sulfite, natamycin, disodium EDTA, butylated hydroxyanisole, butylated hydroxytoluene, tert-butylhydroquinone propyl gallate, ethanol, and methylchloroisothiazolinone.

Food colorings such as FD&C Blue No. 1 (Brilliant Blue FCF), FD&C Blue No. 2 (Indigotine), FD&C Green No. 3 (Fast Green FCF), FD&C Red No. 3 (Erythrosine), FD&C Red No. 40 (Allura Red AC), FD&C Yellow No. 5 (Tartrazine), and FD&C Yellow No. 6 (Sunset Yellow FCF) are contemplated for addition to the formulation to impart a desired color. In a preferred embodiment, FD&C Red No. 40 is added to give the solution a slight pink shade. Coloring is the last ingredient added before the gelling agent to promote a consistent color throughout the solution.

In an embodiment of the invention, the charged micelles 20 or liposomes 30 that encapsulate the one or more active ingredients 22 are dispersed in a delivery matrix solution. The delivery matrix may be a hydrocolloid, or the like.

In one embodiment the hydrocolloid is a hydrogel, which forms an aqueous structure around the micelles 20 or liposomes 30. Many hydrocolloid forming substances are known and can be used in accordance with the invention. Non-limiting examples include cellulose derivatives such as hydroxyethyl cellulose, methylcellulose, and hydroxypropyl-methylcellulose; chemically modified celluloses, xanthan gum, locust bean gum, carrageenans, gellan gums, polyvinyl alcohol, agarose, hyaluronan, pectin, pullulan, and other polymers either synthetically or naturally derived, with the preferred hydrocolloid forming substance being pectin. The pectin is added to the solution after all other ingredients are added. Since pectin is a gelling agent, adding it prior the addition of any other ingredient will cause the formation of a non-homogenous matrix.

The invention contemplates a method of manufacturing the formulation described herein. The method comprises the steps of: charging water to a heating tank, and heating the water to approximately 78-85° C.; transferring the water to a mixing container; mixing the water at a low speed and adding liposome forming agent and mixing; adding base to the solution; adding electrolyte into the solution; encapsulating electrolyte into liposomes and/or micelles; allowing the solution to cool and rest to optimize liposome and/or micelle formation; adding emulsifying agent to the solution and blending; adding flavor and/or sweetener and/or coloring to the solution; adding sodium chloride to the solution; adding preservatives to the solution; adding gelling agent to the solution.

The invention also contemplates orally administering the formulation disclosed herein to an individual in need of one or more electrolytes.

Table 1 summarizes the purposes of ingredients that may be utilized in the current invention.

TABLE 1

| Ingredient | Ingredient Purpose |
|---|---|
| Water, Purified USP | solvent |
| Genu Pectin | Gelling agent |
| Phosphatidyl Serine | Forms carrier liposomes and micelles |
| Grapeseed Oil | Hydrophobic carrier |
| Glycerin 99.7% USP | Emulsifying agent |
| Soy Lecithin | Hydrophobic carrier |
| Sodium Hydroxide | Base to create an anionic surface on |
| | the liposome/micelle |
| Cream Flavor | Flavor oil for palatability |
| Strawberry Flavor | Flavor oil for palatability |
| Sodium Chloride, USP | Source of sodium |
| Potassium Chloride, USP | Source of potassium |
| Magnesium Glycinate | Source of magnesium |
| Calcium Carbonate | Source of calcium |
| Calcium Chloride | Source of calcium |
| Sucralose USP/NF | Sweetener for palatability |
| Acesulfame Potassium, FCC | Sweetener for palatability |
| Citric Acid Anhydrous, USP | Helps with palatability |
| Sodium Benzoate | Preservative |
| Potassium Sorbate | Preservative |
| FD&C Red 40 | Food coloring |

### Examples

The following is an example of an embodiment of the composition and a method of making the composition; the present invention is not necessarily limited thereto.

TABLE 2
Batch JB-EVB10-D7A

| Ingredient | % Weight |
|---|---|
| Water, Purified USP | 60-80% |
| Genu Pectin | 3.7-6% |
| Phosphatidyl Serine | 2.00% |
| Glycerin 99.7% USP | 1-3% |
| Sodium Hydroxide | 0.20% |
| Cream Flavor | 1-1.5% |
| Strawberry Flavor | 1-1.5% |
| Sodium Chloride, USP | 5-16% |
| Potassium Chloride, USP | 1-5% |
| Magnesium Glycinate | 0.1-2% |
| Calcium Carbonate | 0.1-2% |
| Sucralose USP/NF | .25-.75% |
| Acesulfame Potassium, FCC | .25-.75% |
| Citric Acid Anhydrous, USP | .5-1.0% |
| Sodium Benzoate | .01-.05% |
| Potassium Sorbate | .01-.05% |
| FD&C Red 40 | .001-.01% |
| Total: | 100.00% |

An exemplary composition prepared in accordance with the invention is provided in Table 2. This exemplary composition comprises the active ingredients Sodium Chloride, Potassium Chloride, Magnesium Glycinate, and Calcium Carbonate, which are liposomal or micelle encapsulated and/or contained in a plurality of hydrophobic carriers dispersed in an aqueous medium comprising a hydrocolloid. With these active ingredients, the composition functions as an electrolyte delivery solution.

The composition of Table 2 was prepared as follows: purified USP water was heated to approximately 78-85° C. (172-185° F.) in a heating tank. The water was charged to a mixing container, and blended using a high-shear variable speed mixer at 1000 rpm. While blending, phosphatidyl serine was charged to the mixing container.

Still blending at the same speed, sodium hydroxide was charged to the mixing container. This solution was mixed at 3600 RPM for 2-3 minutes.

The speed of the mixing was returned to 1000 rpm while the following listed ingredients were charged to the mixing container in the following order: 1) 90% of the Sodium Chloride, 2) Potassium Chloride, 3) Magnesium Glycinate, and 4) Calcium Carbonate. Once the Calcium Carbonate was added, the solution was blended at 3600 rpm until the appearance of homogeneity was reached.

The mixing was halted, and the solution rested for about 5-7 minutes, allowing the solution to slightly cool. The mixing was resumed at 1000 rpm and the glycerin was added to the solution. Then the mixing was sped up to 2000 rpm until the appearance of homogeneity was reached.

The solution was then mixed at 1000 rpm, and the following ingredients were added in the following order: 1) Citric Acid, 2) Acesulfame Potassium, 3) Cream Flavor, 4) Strawberry Flavor, 5) Sucralose, and 6) 10% of the Sodium Chloride. Once all of these were added to the solution, the speed of mixing was increased to 2000 rpm and blended until the appearance of homogeneity was reached.

Mixing was continued at 1000 rpm and the following ingredients were added to the solution in sequential order: 1) Sodium Benzoate, 2) Potassium Sorbate, and 3) Red #40. Mixing speed was increased to 2000 rpm and the pectin was added to the solution and blended until the appearance of homogeneity was reached.

The following is another example of an embodiment of the composition and should not be considered as limiting in any way.

TABLE 3

| Ingredient | % Weight |
|---|---|
| Water, Purified USP | 60-80% |
| Genu Pectin 150 USA-SAG TYPE D Slow Set | 3.7-6% |
| Grapeseed Oil | .05-3% |
| Glycerin 99.7% USP | 1-3% |
| Soy Lecithin | 0.3-3% |
| Cream Flavoring | 1-1.5% |
| Strawberry Flavoring | 1-1.5% |
| Sodium Chloride, USP | 5-16% |
| Potassium Chloride, USP | 1-5% |
| Magnesium Glycinate | 0.1-2% |
| Calcium Chloride, Anhydrous | 0.1-2% |
| Sucralose USP/NF | .25-.75% |
| Acesulfame Potassium, FCC | .25-.75% |
| Citric Acid Anhydrous, USP | .5-1.0% |
| Sodium Benzoate | .01-.05% |
| Potassium Sorbate | .01-.05% |
| FD&C Red 40 | 0.001-.01% |
| Total: | 100.00% |

Another exemplary composition prepared in accordance with the invention is provided in Table 3. This exemplary composition comprises the active ingredients Sodium Chloride, Potassium Chloride, Magnesium Glycinate, and Calcium Chloride, which are liposomal or micelle encapsulated and/or contained in a plurality of hydrophobic carriers dispersed in an aqueous medium comprising a hydrocolloid. With these active ingredients, the composition functions as an electrolyte delivery solution.

The composition of Table 3 was prepared as follows: purified USP water was heated to approximately 78-85° C. (172-185° F.) in a heating tank. Grapeseed oil and glycerin was mixed together for approximately 1-2 minutes to combine. The heated water was charged to a mixing container; and sodium chloride, potassium chloride, magnesium glycinate and calcium chloride were each added into the mixing container with the heated water and blended at high speed for approximately 1-2 minutes.

The mix of grapeseed oil and glycerin were then added into the mixing container with the other ingredients and blended thoroughly at high speed until homogeneous. This mixture is then allowed to sit for 4-6 minutes.

Next, citric acid, strawberry flavoring, acesulfame potassium, sucralose, cream flavoring and red #40 are added into the mixer and blended thoroughly until homogenous. Sodium benzoate and potassium sorbate are then added and blended until homogenous. Pectin is finally added and blended thoroughly until homogenous.

The invention has been described hereinabove with reference to preferred embodiments. Unless otherwise defined, all technical and scientific terms used herein are intended to have the same meaning as commonly understood in the art to which this invention pertains and at the time of its filing. Although various methods and materials similar or equivalent to those described herein can be used in the practice or testing of the present invention, suitable methods and materials are described. However, the skilled should understand that the methods and materials used and described are examples and may not be the only ones suitable for use in the invention.

Moreover, it should also be understood that any temperature, weight, mass, volume, time interval, pH, salinity, molarity or molality, range, concentration and any other measurements, quantities or numerical figures expressed herein are intended to be approximate and not an exact or critical figure unless expressly stated to the contrary.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the application.

What is claimed is:

1. An oral dosage formulation, comprising:
at least one electrolyte, wherein the at least one electrolyte is contained in a plurality of hydrophobic carriers dispersed in an aqueous medium comprising a hydrocolloid; and
an emulsifier.

2. The formulation of claim 1, wherein the at least one electrolyte is selected from the group consisting of sodium chloride, potassium chloride, magnesium glycinate, acesulfume potassium, potassium sorbate, magnesium chloride, calcium chloride, and combinations thereof.

3. The formulation of claim 1, wherein the at least one electrolyte is about 1% to about 20% (w/w) of the formulation.

4. The formulation of claim 1, wherein the hydrophobic carriers are oils.

5. The formulation of claim 1, wherein the hydrophobic carriers are selected from the group consisting of grapeseed oil, lecithin, phosphatidylserine, and combinations thereof.

6. The formulation of claim 1, wherein the hydrophobic carriers are about 0.05% to about 3% (w/w) of the formulation.

7. The formulation of claim 1, wherein the emulsifier is selected from the group consisting sodium stearoyl lactylate, cetearyl alcohol, polysorbates, polyoxyethylene ethers, polyethylene glycol, anisolic compounds, glycerine, and combinations thereof.

8. The formulation of claim 1, wherein the emulsifier is glycerine.

9. The formulation of claim 1, wherein the emulsifier is about 1% to about 3% (w/w) of the formulation.

10. The formulation of claim 1, further comprising a permeation enhancer.

11. The formulation of claim 11, wherein the permeation enhancer is selected from the group consisting of menthol, menthyl acetate, DDAIP, fatty acid esters, fatty alcohol ethers, ethanol, dimethylsulfoxide, polyethylene glycol monolaurate, sesquiterpenes, terpenoids, sesquiterpenoids, and terpenes.

12. The formulation of claim 11, wherein the permeation enhancer is menthol.

13. The formulation of claim 11, wherein the permeation enhancer is about 0.2% to about 7% (w/w) of the formulation.

14. The formulation of claim 1, wherein the hydrocolloid is selected from the group consisting of hydroxyethylcellulose, methylcellulose, hydroxypropyl-methylcellulose, chemically modified celluloses, xanthan gum, locust bean gum, carrageenans, gellan gums, polyvinyl alcohol, agarose, hyaluronan, pectin, pullulan, and combinations thereof.

15. The formulation of claim 1, wherein the hydrocolloid is pectin.

16. The formulation of claim 1, further comprising a vasostimulant.

17. The formulation of claim 17, wherein the vasostimulant is selected from the group consisting of nicotinic acid, caffeine and combinations thereof.

18. The formulation of claim 17, wherein the vasostimulant is about 0.2% to about 7% (w/w) of the formulation.

19. An oral dosage formulation, comprising:
at least one electrolyte, wherein the at least one electrolyte is contained in a plurality of hydrophobic carriers dispersed in an aqueous medium comprising pectin; and
at least one emulsifier.

20. The formulation of claim 20, wherein the at least one emulsifier is selected from the group consisting of glycerin, lecithin, and combinations thereof.

21. The formulation of claim 20, wherein the at least one electrolyte is selected from the group consisting of sodium chloride, potassium chloride, magnesium glycinate, magnesium chloride, calcium chloride, and combinations thereof.
